(19) United States
(12) Patent Application Publication
(10) Pub. No.: US 2024/0375597 A1
(43) Pub. Date: Nov. 14, 2024

(54) WIRE HARNESS FOR VEHICLE DIGITAL DASHBOARD CONVERSION

(71) Applicant: Newrad Solutions, LLC, Lee, NH (US)

(72) Inventor: Daren W. Keller, Lee, NH (US)

(21) Appl. No.: 18/195,521

(22) Filed: May 10, 2023

(51) Int. Cl. B60R 16/02

(52) U.S. Cl. CPC B60R 16/0207

(57) ABSTRACT

A wire harness for a vehicle digital dashboard retrofit conversion for a vehicle manufacturer is provided. The wire harness includes a rectangular housing body having a hollow interior forming a perimeter surface. The rectangular housing has a number of pins positioned within the housing. A number of preconnected wires electrically connected to the number of pins is provided, and the hollow interior of the rectangular housing body is sized and shaped to accept a male OEM connector for receiving gauge signals, such that a number of leads provided on the male OEM connector electrically connect to the number of pins. The number of preconnected wires are configured to electrically connect to a digital dashboard directly or indirectly such that the vehicle may be retrofitted with the digital dashboard.

### CROSS-REFERENCE TO RELATED APPLICATIONS

N/A

### BACKGROUND OF THE INVENTION

### 1. Field of the Invention

The present invention relates to vehicle refurbishment but more particularly to a wire harness for vehicle digital dashboard conversion.

### 2. Description of Related Art

Vehicle refurbishment or retrofitting is the process of improving a used vehicle in one or more aspects including electronics, interiors, body, etc. From the 1970s until the 1990s, vehicle manufacturers used old analog gauge technology. Often, a popular refurbishment process is updating the analog dashboards with digital dashboards. However, the process is time consuming and requires the user to have to trace wiring diagrams and splice wires, leading to possible failures. Consequently, a solution is provided.

### BRIEF SUMMARY OF THE INVENTION

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

It is an object of the present invention to simplify the installation process of modern digital dashboards into older vehicles. It is an object of the present invention to provide a wire harness for a vehicle digital dashboard conversion for a number of vehicle manufacturers, preventing the need for manually splicing into the OEM gauge connectors, saving installation time and preventing errors. It is another object of the present invention to provide a device that reduces the wiring knowledge needed. It is another object of the invention to provide a reversible solution, which leaves vehicle connectors and wire in a pre-installation condition.

In order to do so, a wire harness for a vehicle digital dashboard retrofit conversion for a vehicle manufacturer is provided, the vehicle having an OEM connector for receiving gauge signals, the wire harness comprising a rectangular housing body having a hollow interior, forming a perimeter surface including a front side, a rear side, a left side, and a right side; a number of pins positioned on the front side and the rear side of the perimeter; a number of preconnected wires electrically connected to the number of pins; wherein hollow interior of the rectangular housing body is sized and shaped to accept the OEM connector such that a number of leads provided on the OEM connector electrically connect to the number of pins; and, wherein the number of preconnected wires are configured to electrically connect to a digital dashboard directly or indirectly such that the vehicle may be retrofitted with the digital dashboard.

In one embodiment, the rectangular housing body includes protrusions and openings on the left side and the right side to removably accept a clip or tab provided on the OEM connector. In one embodiment, each wire of the number of preconnected wires is labeled. In one embodiment, each wire of the number of preconnected wires is labeled. In another embodiment, each pin of the number of pins is labeled on the rectangular housing body.

In another aspect of the invention, a method for retrofitting a vehicle having an analog gauge cluster dashboard with a digital gauge cluster dashboard, the method comprising steps (a) removing the analog gauge cluster dashboard and exposing a male OEM connector, wherein the male OEM connector is configured to receive gauge signals; (b) providing a female wire harness comprising a rectangular housing body having a hollow interior, including a number of pins electrically connected to a number of preconnected wires extending from the wire harness, wherein the wire harness is sized and shaped to receive the male OEM connector; (c) mating the male OEM connector within the female wire harness such that the number of pins are electrically connected to a number of leads provided on the male OEM connector; and, (e) electrically connecting the number of preconnected wires to a digital circuit or control box connected to the digital gauge cluster dashboard.

The foregoing has outlined rather broadly the more pertinent and important features of the present disclosure so that the detailed description of the invention that follows may be better understood and so that the present contribution to the art can be more fully appreciated. Additional features of the invention will be described hereinafter which form the subject of the claims of the invention. It should be appreciated by those skilled in the art that the conception and the disclosed specific methods and structures may be readily utilized as a basis for modifying or designing other structures for carrying out the same purposes of the present disclosure. It should be realized by those skilled in the art that such equivalent structures do not depart from the spirit and scope of the invention as set forth in the appended claims.

### BRIEF DESCRIPTION OF THE SEVERAL VIEWS OF THE DRAWINGS

Other features and advantages of the present invention will become apparent when the following detailed description is read in conjunction with the accompanying drawings, in which:

FIG. 1A is a front view of an analog dashboard of the prior art.

FIG. 1B is a rear view of the analog dashboard of FIG. 1A.

FIG. 1C is a perspective view of an OEM connector of the prior art.

FIG. 1D is an exemplary example of a digital dash control box as known in the art.

FIG. 2 is a perspective view of a wire harness for vehicle digital dashboard conversion, according to an embodiment of the present invention.

FIG. 3 is a front view of the wire harness of FIG. 2.

FIG. 4 is a top view of the wire harness of FIG. 2.

FIG. 5A is an exemplary instance of an alternate wire harness and an OEM connector for vehicle digital dashboard conversion, according to an embodiment of the present invention.

FIG. 5B shows the alternative wire harness connected to the OEM connector.

FIG. 5C is a top view of the alternate wire harness of FIG. 5A.

FIG. 6A is an exemplary instance of a second alternate wire harness and an OEM connector for vehicle digital dashboard conversion, according to an embodiment of the present invention.

FIG. 6B shows the second alternative wire harness connected to the OEM connector.

FIG. 6C is a top view of the second alternate wire harness of FIG. 6A.

FIG. 6D is a front view of the second alternate wire harness of FIG. 6A.

FIG. 6E is a rear view of the second alternate wire harness of FIG. 6A.

FIG. 6F is a right side view of the second alternate wire harness of FIG. 6A.

FIG. 6G is a left side view of the second alternate wire harness of FIG. 6A.

FIG. 7A is an exemplary instance of a third alternate wire harness and an OEM connector for vehicle digital dashboard conversion, according to an embodiment of the present invention.

FIG. 7B shows the third alternative wire harness connected to the OEM connector.

FIG. 7C is a top view of the third alternate wire harness of FIG. 7A.

FIG. 7D is a front view of the third alternate wire harness of FIG. 7A.

FIG. 7E is a rear view of the third alternate wire harness of FIG. 7A.

FIG. 7F is a right side view of the third alternate wire harness of FIG. 7A.

FIG. 7G is a left side view of the third alternate wire harness of FIG. 7A.

FIG. 8A is an exemplary instance of a fourth alternate wire harness and an OEM connector for vehicle digital dashboard conversion, according to an embodiment of the present invention.

FIG. 8B shows the fourth alternative wire harness connected to the OEM connector.

FIG. 8C is a top view of the fourth alternate wire harness of FIG. 8A.

FIG. 8D is a front view of the fourth alternate wire harness of FIG. 8A.

FIG. 8E is a rear view of the fourth alternate wire harness of FIG. 8A.

FIG. 8F is a left side view of the fourth alternate wire harness of FIG. 8A.

FIG. 8G is a right side view of the fourth alternate wire harness of FIG. 8A.

FIG. 9A is an exemplary instance of a fifth alternate wire harness and an OEM connector for vehicle digital dashboard conversion, according to an embodiment of the present invention.

FIG. 9B shows the fifth alternative wire harness connected to the OEM connector.

FIG. 9C is a top view of the fifth alternate wire harness of FIG. 9A.

FIG. 9D is a front view of the fifth alternate wire harness of FIG. 9A.

FIG. 9E is a rear view of the fifth alternate wire harness of FIG. 9A.

FIG. 9F is a left side view of the fifth alternate wire harness of FIG. 9A.

FIG. 9G is a right side view of the fifth alternate wire harness of FIG. 9A.

FIG. 10A is an exemplary instance of a sixth alternate wire harness and an OEM connector for vehicle digital dashboard conversion, according to an embodiment of the present invention.

FIG. 10B shows the sixth alternative wire harness connected to the OEM connector.

FIG. 10C is a top view of the sixth alternate wire harness of FIG. 10A.

FIG. 10D is a front view of the sixth alternate wire harness of FIG. 10A.

FIG. 10E is a rear view of the sixth alternate wire harness of FIG. 10A.

FIG. 10F is a left side view of the sixth alternate wire harness of FIG. 10A.

FIG. 10G is a right side view of the sixth alternate wire harness of FIG. 10A.

FIG. 11A is an exemplary instance of a seventh alternate wire harness and an OEM connector for vehicle digital dashboard conversion, according to an embodiment of the present invention.

FIG. 11B shows the seventh alternative wire harness connected to the OEM connector.

FIG. 11C is a top view of the seventh alternate wire harness of FIG. 11A.

FIG. 11D is a front view of the seventh alternate wire harness of FIG. 11A.

FIG. 11E is a rear view of the seventh alternate wire harness of FIG. 11A.

FIG. 11F is a left side view of the seventh alternate wire harness of FIG. 11A.

FIG. 11G is a right side view of the seventh alternate wire harness of FIG. 11A.

### DETAILED DESCRIPTION OF THE PREFERRED EMBODIMENT

The following description is provided to enable any person skilled in the art to make and use the invention and sets forth the best modes contemplated by the inventor of carrying out his invention. Various modifications, however, will remain readily apparent to those skilled in the art, since the general principles of the present invention have been defined herein to specifically provide a wire harness for vehicle digital dashboard conversion.

It is to be understood that the terminology used herein is for the purpose of describing particular embodiments only and is not intended to be limiting. The terms “a” or “an,” as used herein, are defined as to mean “at least one.” The term “plurality,” as used herein, is defined as two or more. The term “another,” as used herein, is defined as at least a second or more. The terms “including” and/or “having,” as used herein, are defined as comprising (i.e., open language). The term “providing” is defined herein in its broadest sense, e.g., bringing/coming into physical existence, making available, and/or supplying to someone or something, in whole or in multiple parts at once or over a period of time. These terms generally refer to a range of numbers that one of skill in the art would consider equivalent to the recited values (i.e., having the same function or result). In many instances these terms may include numbers that are rounded to the nearest significant figure.

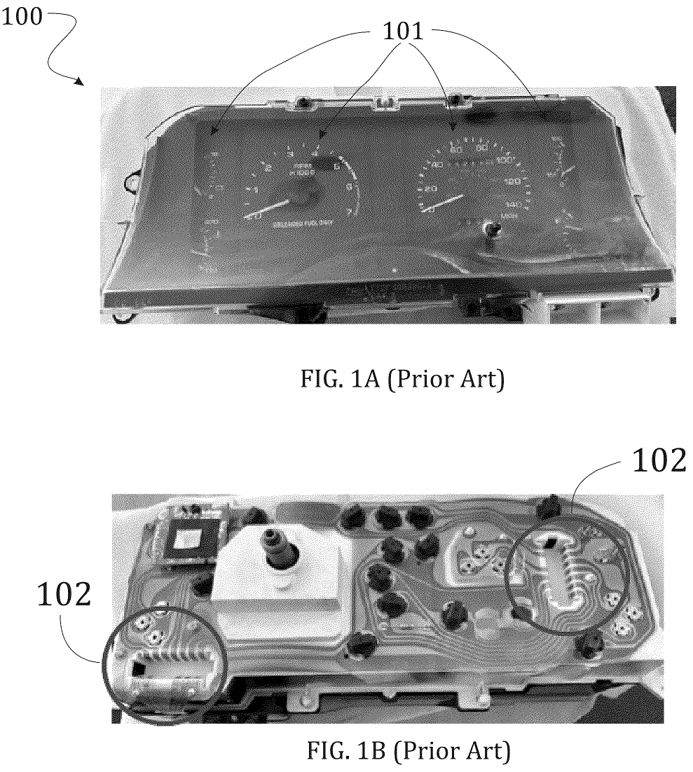

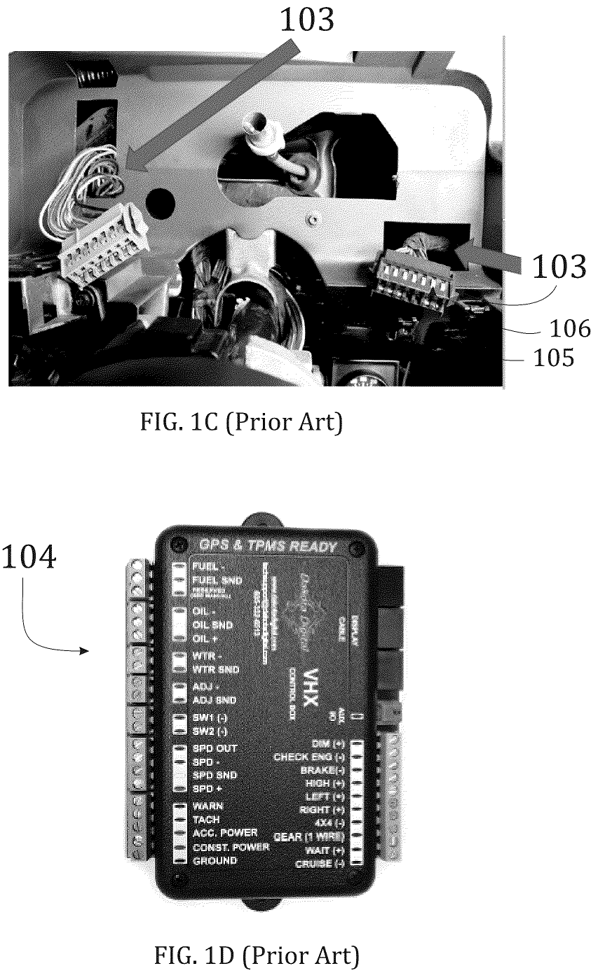

Referring to prior art FIGS. 1A-D, vehicle manufactures, such as General Motors® and Ford®, made analog dashboards 100 having gauge clusters 101, wherein the dashboards have female input cavities 102 configured to accept a male wire connector 103 which is wired to gauge sensors (not shown) for various statistics such as oil pressure, water temperature, fuel level, speedometer, tachometer, etc. as well known in the art. Currently, users have to splice and combine new wires to the existing male wires found leading to the male wire connector 103, via wire caps, terminals, soldering or other methods known in the art, into a digital dash control box 104 or digital circuit which is connected to the digital dashboard. Alternatively, if wires are of sufficient length, users can cut, strip, and connect wires to the digital dash control box or digital circuit. Either way, it is a very time consuming process to retrofit a digital dashboard into a vehicle designed for analog dashboards as discussed. This process also required the user to have knowledge of wiring colors, i.e. what the color of each wire means, and where the wire should be connected. The present invention prevents this requirement.

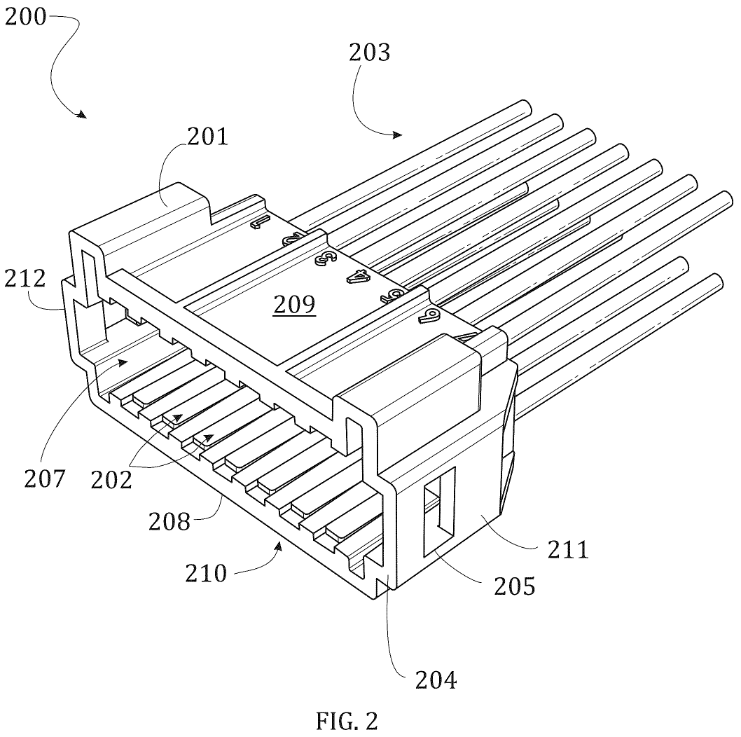

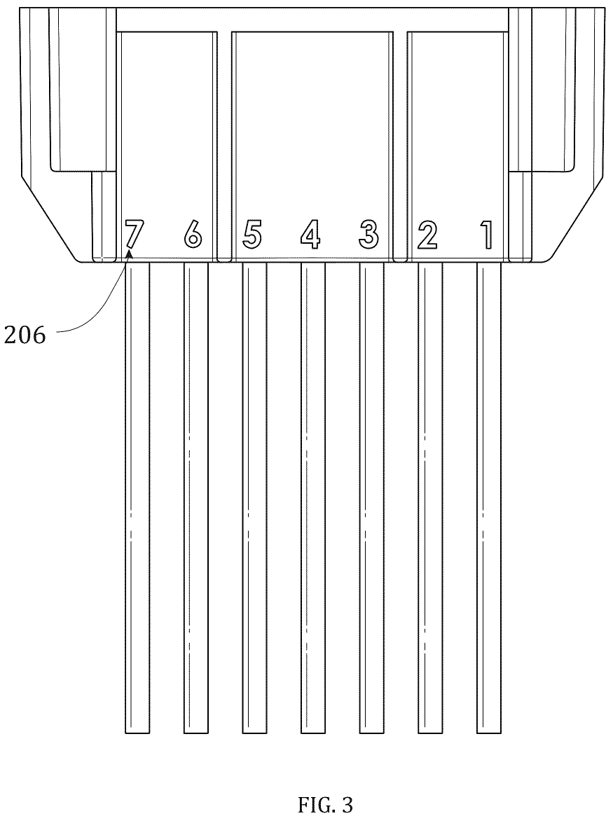

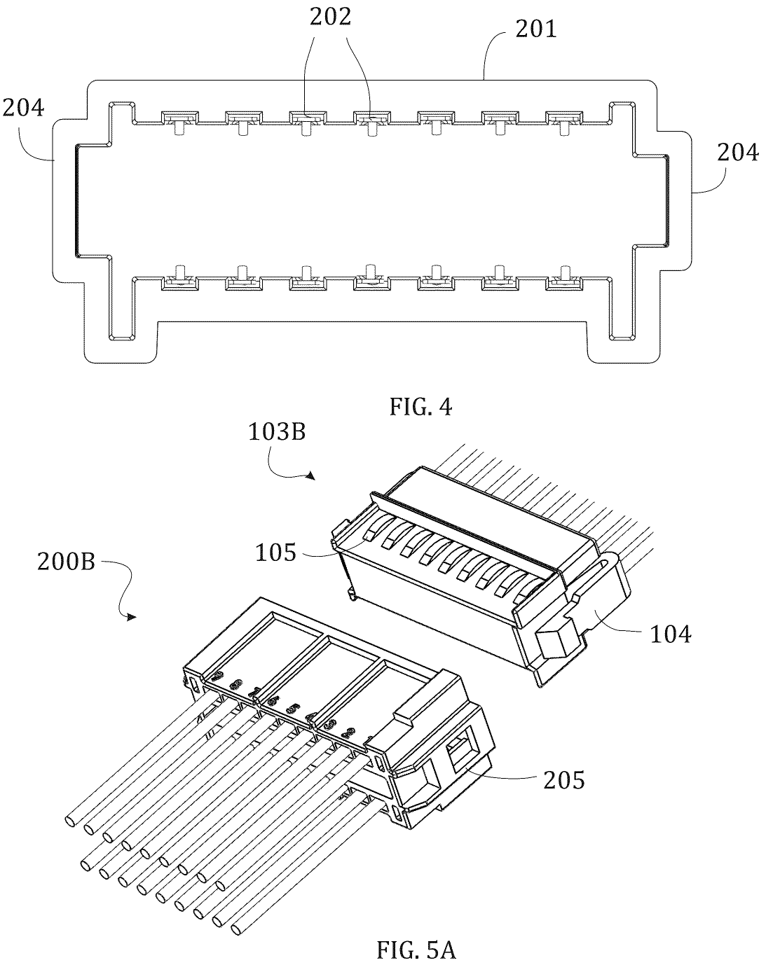

Referring now to FIGS. 2-4, a wire harness 200 for vehicle digital dashboard conversion is illustrated. Advantageously, the present invention provides a means for eliminating the need for any wire modification. In one embodiment, the wire harness 200 comprises a housing body 201 shaped and sized to match an existing original equipment manufacturer (OEM) connector (103; FIG. 1C), wherein the housing body 201 is configured to mate with its corresponding OEM connector. Generally, the housing body 201 is rectangular with a hollow interior 207 having various indentations and protrusions which will be discussed in greater details below. The hollow interior 207 acts as the female space to receive the shape of the male OEM connector and forms a perimeter surface 208 having a front side 209, a rear side 210, a left side 211, and a right side 212. In one embodiment, the housing body 201 includes a number of pins 202, wherein the number of pins 202 are configured to electrically connect to the leads (105; FIG. 1C) of the OEM connector when mated. In some embodiments, the number of pins are equally distributed between the interior surfaces of the front side and the rear side. Advantageously, the shape of the housing body 201 prevents user error in the connection between the wire harness 200 and OEM connector, i.e. the present invention is mistake proof.

In one embodiment, a number of wires 203 are provided and preconnected, wherein each wire includes a lead electrically connected to the number of pins 202. In some embodiments, within the housing body, each lead of the number of wires is soldered or otherwise hardwired electrically with each corresponding pin of the number of pins 202. Advantageously, the preconnected wires are protected via loom and heat shrinking. In some embodiments, to make installation simple, each wire of the number of wires 203 includes labeling so the user knows where to connect the wires to the digital dash control box, e.g. 104; FIG. 1D. In some embodiments, the preconnected wires are connected at an angle or offset an angle via the wire shape, or the pin positioning within the housing body, wherein the angle is between 1-90 degrees. In yet another embodiment, the wires are not preconnected and may be manually connected by the user.

In some embodiments, on opposite ends of the housing body 201 are attachment protrusions 204 having openings 205 to accommodate clips/tabs (106; FIG. 1C), such that when the OEM connector (103; FIG. 1C) connects to the wire harness, the connection is secure and the electrical circuit is stable. It should be understood that in alternative embodiments, other connection methods may be possible.

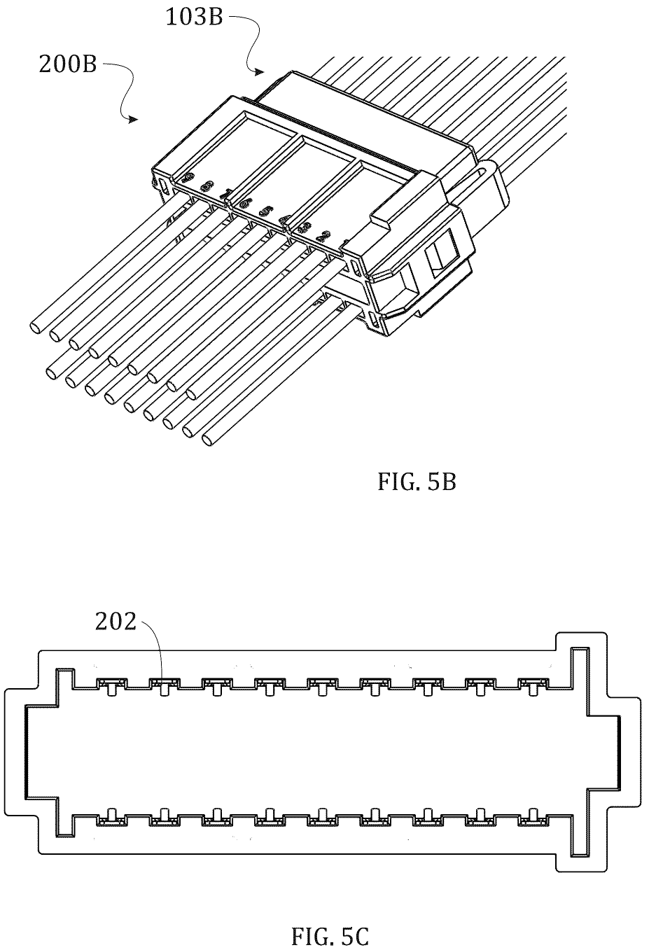

In some embodiments, the shape of the housing body 201 is such that the connection between the OEM connector and the wire harness 200 is only possible one way. Overall, the shape of the housing body 201 is configured to match the shape of the OEM connector, including any protrusions or indentations that may be present. That said, recognizing that many vehicle manufacturers provide different shaped OEM connectors, it is understood that the shape of the housing body 201 may vary depending on the vehicle in which the present invention is installed. For example, FIGS. 5-7, show various wire harness embodiments having slightly different housing body configurations. However, the general principle is the same. Further, the number of pins provided may vary. For example, General Motors®provides 12, 14, and 18 pin OEM connectors depending on the specific vehicle or brand, such as Chevrolet®, Buick®, etc. In the embodiment shown in FIG. 2, the number of pins is 14. In some embodiments, each pin number is labeled 206. In some embodiments, other insignia, identifying text, or similar may be provided to identify which vehicle manufacturer or brand the specific wire harness embodiment is intended for.

Referring now to FIGS. 5A-C, a wire harness 200B configured for Ford® 18 pin is illustrated. The components and function of the wire harness is as previously described herein. The wire harness 200B includes a body housing 201 configured to receive a Ford® 18 pin OEM connector 103B, wherein the leads 105 of the OEM connector are electrically connected to the pins 202 within the body housing 201 when the OEM connector is mated with the wire harness 200B. A tab 104 is configured to snap on the provided opening 205 on the body housing 201. The profile (best seen in FIG. 5C) is sized and shaped to match the OEM connector.

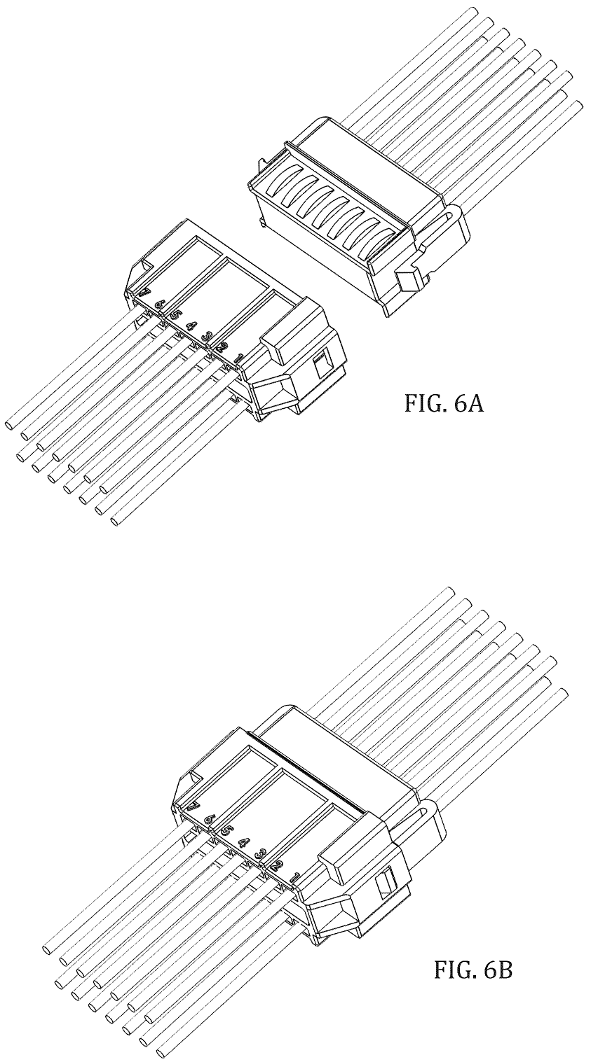

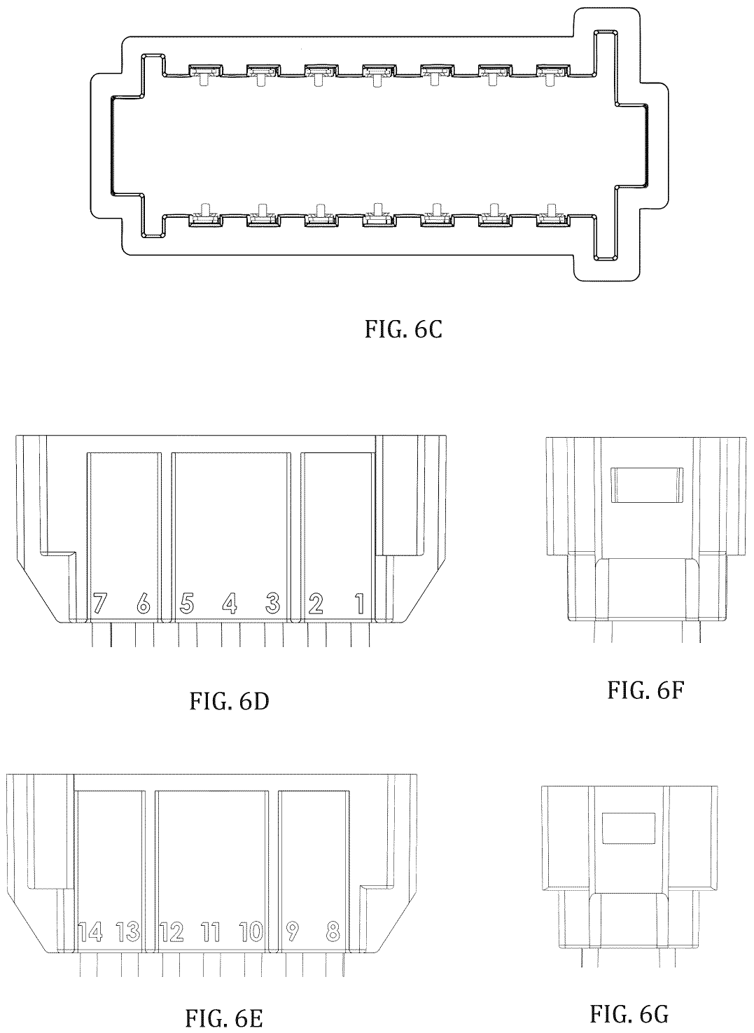

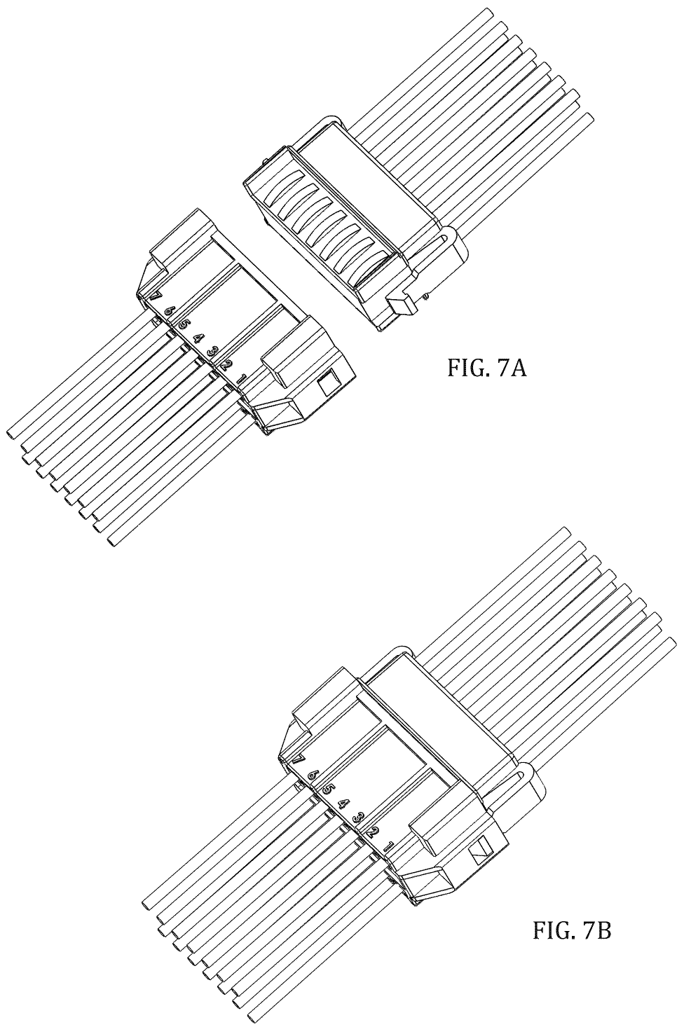

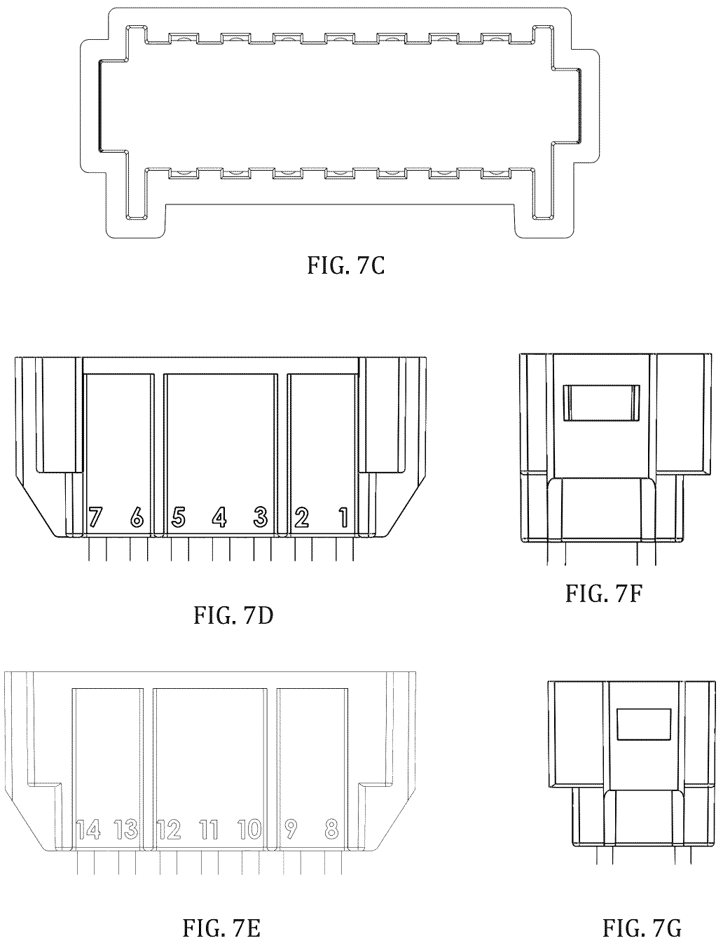

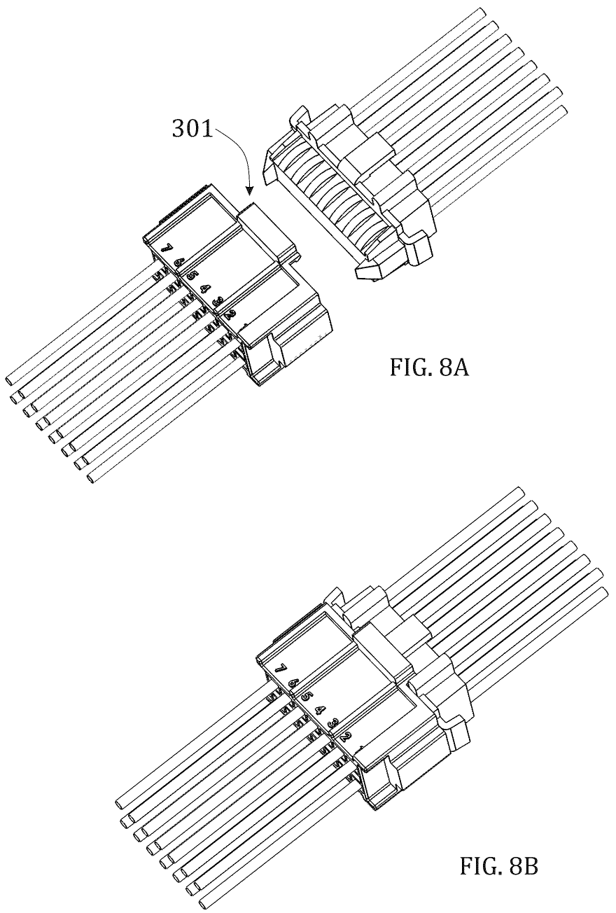

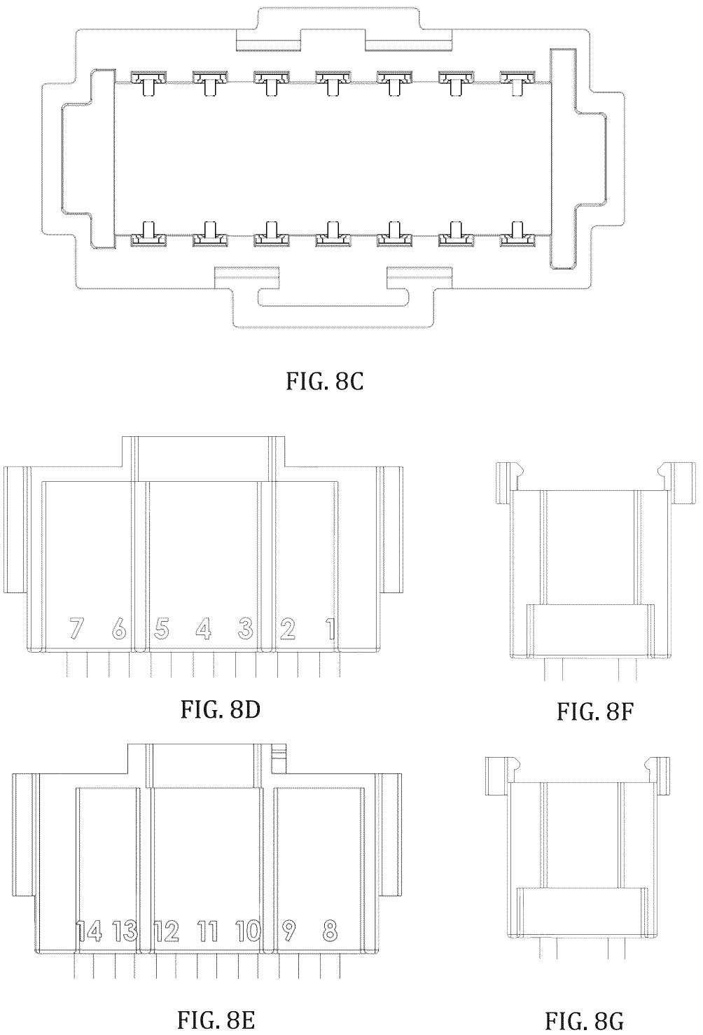

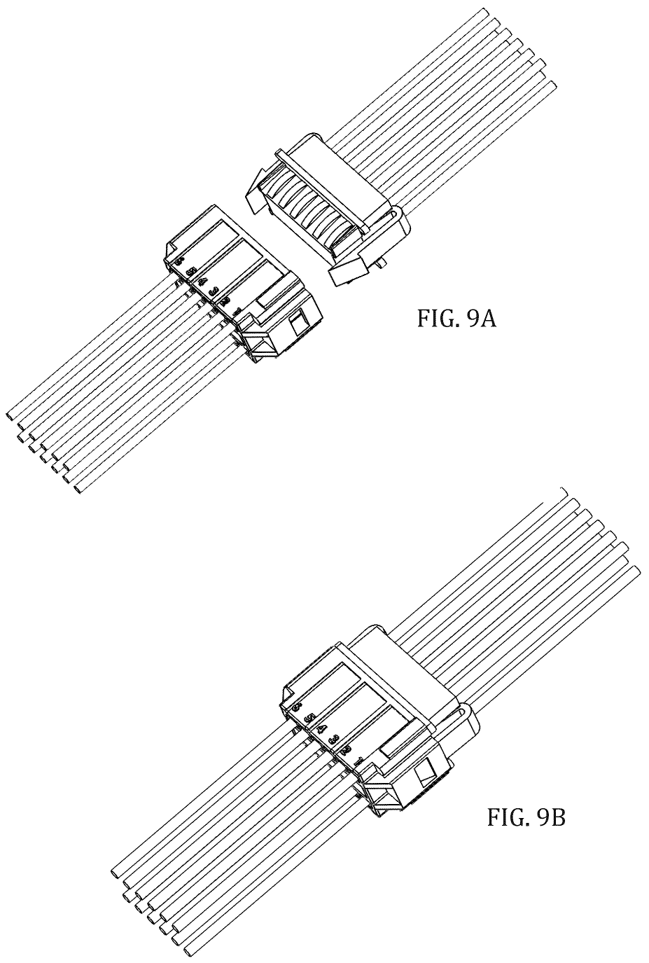

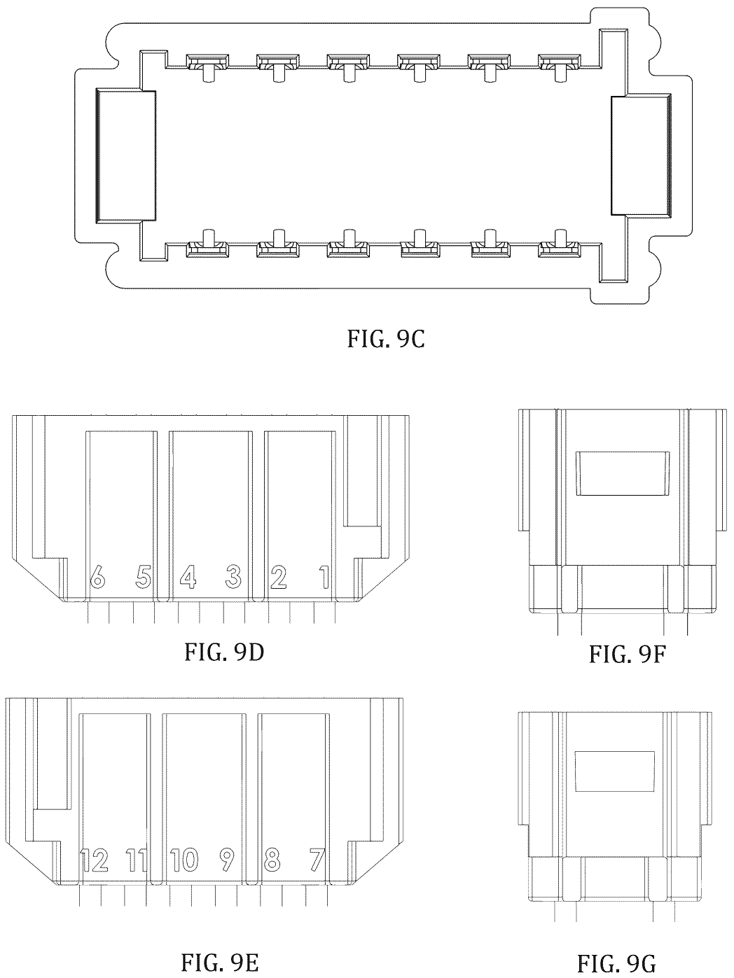

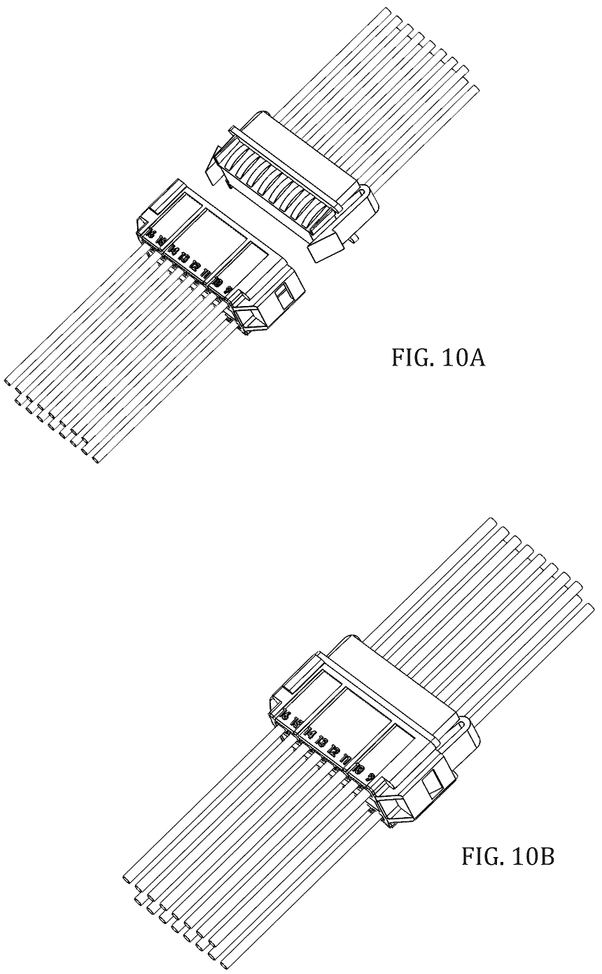

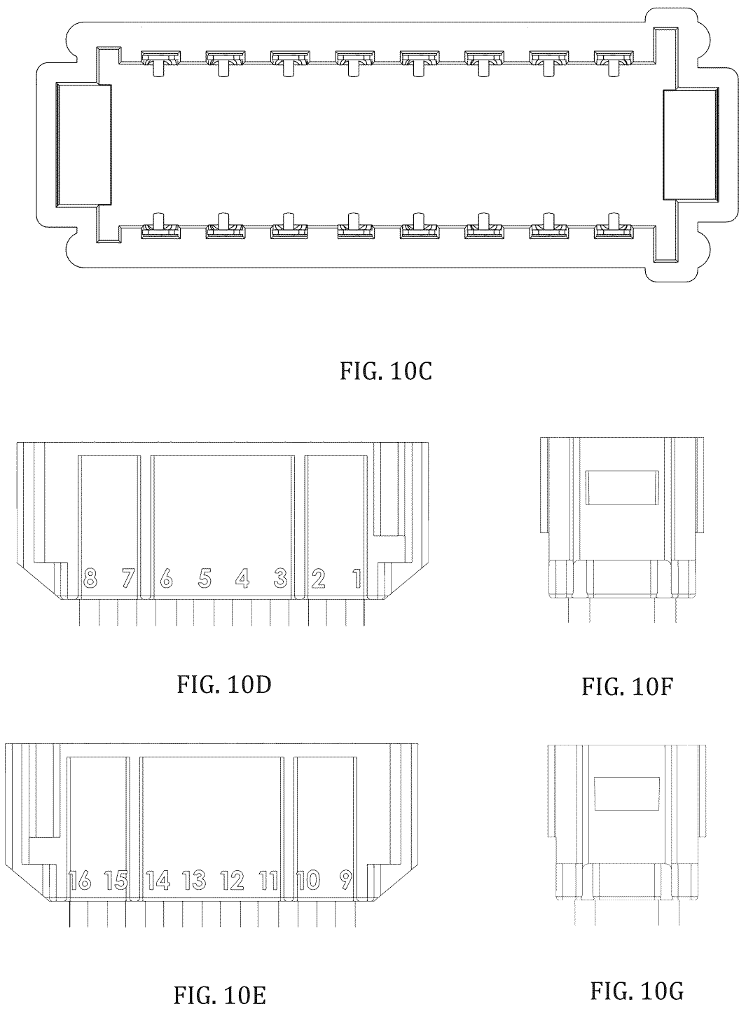

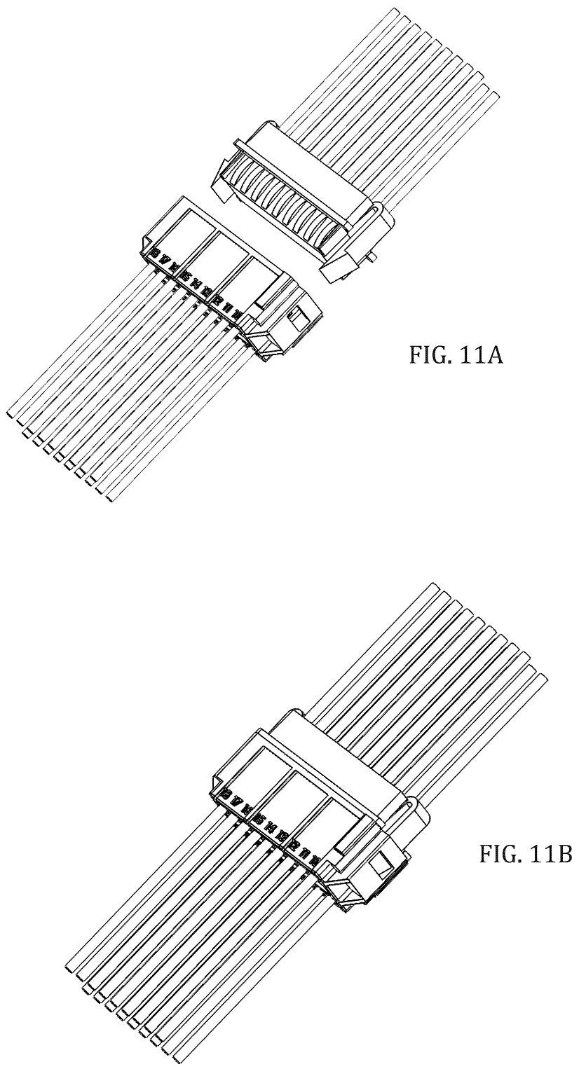

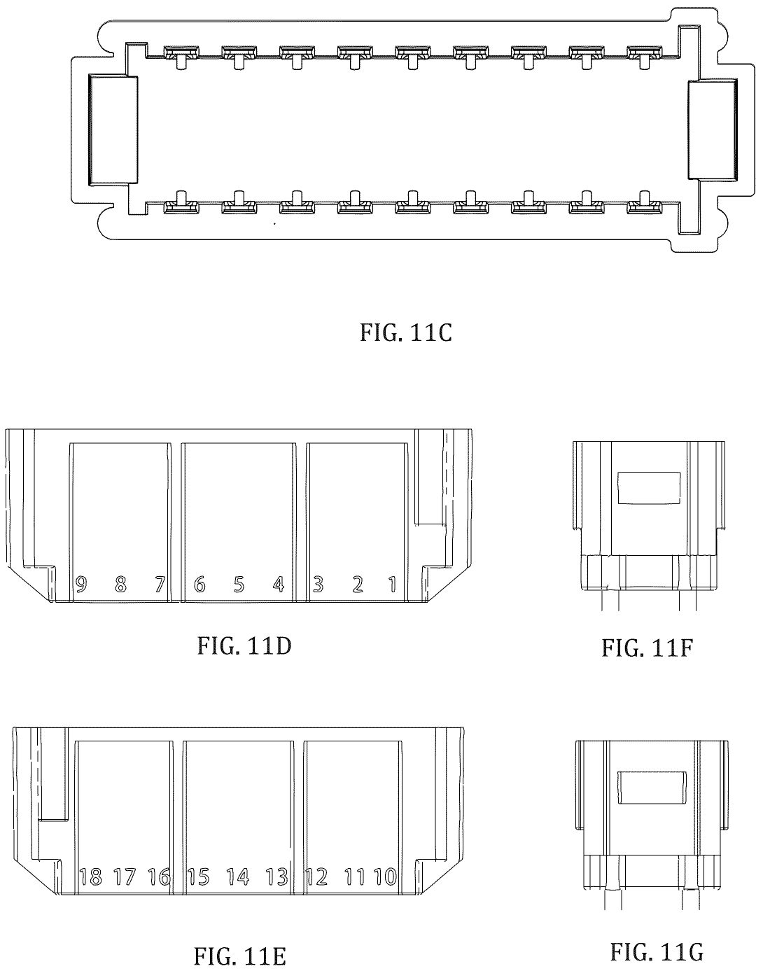

As previously mentioned, the size and shape of the wire harness, including the number of pins may vary depending on the vehicle manufacturer. As an example, FIGS. 6A-G illustrate various views of a wire harness intended to mate with a Ford® 14 pin C250 OEM connector. Likewise, FIGS. 7A-G illustrate various views of a wire harness intended to mate with a Ford® 14 pin C251 OEM connector. Similarly, FIGS. 8A-G illustrate various views of a wire harness intended to mate with a General Motors® 14 pin connector. In this embodiment, the wire harness includes a centralized snap-fit mechanism 301 in addition to the clip/tab attachment on each opposing side of the body housing as previously discussed. The snap-fit mechanism ensures the OEM connector is locked within the wire harness body. It should be understood that the wire harness of the present invention may be modified to conform to any attachment means, clips, snaps, or similar locking devices that may be provided on the specific OEM connector. Further, FIGS. 9A-G, illustrate various views of a wire harness intended to mate with a General Motors® 12 pin connector, FIGS. 10A-G, illustrate various views of a wire harness intended to mate with a General Motors® 16 pin connector, and FIGS. 11A-G, illustrate various views of a wire harness intended to mate with a General Motors® 18 pin connector.

During use, a user simply selects the specific wire harness 200 intended for a specific vehicle manufacturer or brand, using the insignia, identifying text, number of pins, etc. as a guide for selection if necessary, and inserts the OEM connector for the specific vehicle manufacture into the wire harness 200. Then, the user connects the terminal ends or leads of the preconnected/attached wires 203 to the digital dash control box or digital circuit board, essentially electrically connecting the OEM connector to the digital dashboard (not illustrated) in a simple, time effective, and efficient way, while reducing the possibility of human error.

Although the invention has been described in considerable detail in language specific to structural features, it is to be understood that the invention defined in the appended claims is not necessarily limited to the specific features described. Rather, the specific features are disclosed as exemplary preferred forms of implementing the claimed invention. Stated otherwise, it is to be understood that the phraseology and terminology employed herein, as well as the abstract, are for the purpose of description and should not be regarded as limiting. Therefore, while exemplary illustrative embodiments of the invention have been described, numerous variations and alternative embodiments will occur to those skilled in the art. Such variations and alternative embodiments are contemplated, and can be made without departing from the spirit and scope of the invention. For example, for added strength, the hollow interior, a portion of the hollow interior, the pins, or other portions of the wire harness may be molded, filled-in, etc. with epoxy or other materials preventing electrical connections from failures or tampering.

It should further be noted that throughout the entire disclosure, the labels such as left, right, front, back, top, bottom, forward, reverse, clockwise, counterclockwise, up, down, or other similar terms such as upper, lower, aft, fore, vertical, horizontal, oblique, proximal, distal, parallel, perpendicular, transverse, longitudinal, etc. have been used for convenience purposes only and are not intended to imply any particular fixed direction or orientation. Instead, they are used to reflect relative locations and/or directions/orientations between various portions of an object.

In addition, references to “first,” “second,” “third,” and etc. members throughout the disclosure (and in particular, claims) are not used to show a serial or numerical limitation but instead are used to distinguish or identify the various members of the group.

What is claimed is:

1. A wire harness for a vehicle digital dashboard retrofit conversion for a vehicle manufacturer, the vehicle having an OEM connector for receiving gauge signals, the wire harness comprising:
a rectangular housing body having a hollow interior, forming a perimeter surface including a front side, a rear side, a left side, and a right side;
a number of pins positioned on the front side and the rear side of the perimeter;
a number of preconnected wires electrically connected to the number of pins;
wherein the hollow interior of the rectangular housing body is sized and shaped to accept the OEM connector such that a number of leads provided on the OEM connector electrically connects to the number of pins; and,
wherein the number of preconnected wires are configured to electrically connect to a digital dashboard directly or indirectly such that the vehicle may be retrofitted with the digital dashboard.

2. The wire harness of claim 1, wherein the rectangular housing body includes protrusions and openings on the left side and the right side to removably accept a clip or tab provided on the OEM connector.

3. The wire harness of claim 1, wherein each wire of the number of preconnected wires is labeled.

4. The wire harness of claim 1, wherein each wire of the number of preconnected wires is labeled.

5. The wire harness of claim 1, wherein each pin of the number of pins is labeled on the rectangular housing body.

6. A method for retrofitting a vehicle having an analog gauge cluster dashboard with a digital gauge cluster dashboard, the method comprising steps:
(a) removing the analog gauge cluster dashboard and exposing a male OEM connector, wherein the male OEM connector is configured to receive gauge signals;
(b) providing a female wire harness comprising a rectangular housing body, having a hollow interior, including a number of pins electrically connected to a number of preconnected wires extending from the wire harness, wherein the wire harness is sized and shaped to receive the male OEM connector;
(c) mating the male OEM connector within the female wire harness such that the number of pins are electrically connected to a number of leads provided on the male OEM connector; and,
(d) electrically connecting the number of preconnected wires to a digital circuit or control box connected to the digital gauge cluster dashboard.
